(19) United States
(12) Patent Application Publication
(10) Pub. No.: US 2008/0193712 A1
(43) Pub. Date: Aug. 14, 2008

(54) Structurally insulated - integrated building panel

(76) Inventor: Paul A. Desjardins, Harpswell, ME (US)

Correspondence Address: Charles F. Seyboldt, 19 Ridgeview Drive, Standish, ME, 04084, US

(21) Appl. No.: 11/704,569

(22) Filed: Feb. 10, 2007

(51) Int. Cl. B32B 7/04

(52) U.S. Cl. 428/119

(57) ABSTRACT

A structurally insulated-integrated building panel is provided that is suited for use as a floor, roof, or wall panel of a building. The structurally insulated-integrated building panel uses one formed-rigid skin, one cementatious or concrete-like skin, and a foam insulating core in a sandwich-like arrangement. Reinforcing members integrate the skins and the foam core. One edge of each reinforcing member is bonded to the formed-rigid skin with screw fasteners, welding or adhesives, the other edge is embedded in the cementatious skin, and the foam core is either formed around or adhesively bonded to the parts of the reinforcing member that remain exposed. The formed-rigid skin can be made of metal or reinforced resin composites, and includes formed ridges to regulate the location and facilitate bonding of the reinforcing members.

### BACKGROUND OF THE PRESENT INVENTION

### Summary of the Prior Art

This invention relates to a structurally insulated building panel, and more particularly to a structurally insulated-integrated building panel wherein the various constituent parts are selected and interconnected in a way to optimize the stress distribution between the parts, and to simplify the building panel fabrication process.

U.S. Pat. No. 4,942,707, to Erik W. Huettemann describes a concrete over foam over plywood construction, where the construction has alternating and bonded ribs of foam and concrete. The invention of Huettemann has no independent internal reinforcing members.

U.S. Pat. No. 5,930,965 to Tommy Lee Carver describes an insulated deck structure with internal reinforcing members running nominally from top to bottom of a floor panel, where the reinforcing members are encased in the same concrete structure that comprises the floor of the deck.

U.S. Pat. No. 6,244,008 to John Fullarton Miller describes a lightweight floor panel that is concrete over foam, having internal reinforcing disposed between foam ribs. Both skins are a concrete-like material, and the internal reinforcing is eventually cast into and bonded with the concrete skins.

U.S. Pat. No. 6,085,485 to Douglas G. Murdock describes a hollow steel structural panel with features that facilitate multiple panels into a larger unit. Murdock's panel incorporates “Z” or “C” section reinforcing members, within its hollow core space, where the reinforcing members are fastened to both skin faces of the panel.

U.S. Pat. No. 6,000,194 to Mitsuo Nakamura describes a structural panel where both skin surfaces are concrete or reinforced concrete. The skin surfaces are cast over a unitary corrugated interior reinforcing plate. The spaces in the corrugation can be filled with a foam insulating material.

“Green Sandwich Technologies” of North Hollywood, Calif. produces structural panels having a foam core, where the skin surfaces are a reinforced concrete-like material. The “Green Sandwich” panels are erected into a structure as foam core with attached steel wire reinforcing, and the concrete or concrete-like outer skins are sprayed, hand-troweled, poured or otherwise applied. The outer skin thickness fills the preset space from the foam core to the reinforcing wires, and then to whatever thickness is directed by architectural and structural requirements.

### SUMMARY OF THE PRESENT INVENTION

The present invention contemplates a structurally integrated building panel having one formed-rigid skin, one cementations skin, and a hollow core filled with a foam insulating material in combination with panel-integrating reinforcing members. The panel-integrating reinforcing members are designed to be fastened, bonded or embedded to each skin, and are also bonded to the foam core insulating material to make a strong unitary structure.

The cementations skin is usually arranged to be above the formed-rigid skin, so that when a building panel is carrying a load from above, the stresses on the cementations skin will be compressive, while the stresses on the formed-rigid skin will be tensile.

In one embodiment, the formed-rigid skin member is contemplated to be a substantially flat structure, for example, sheet metal, having longitudinal ridges or other geometric shapes spaced and shaped to facilitate the quick and reliable location (without the use of assembly jigs) and sturdy connection of the panel-integrating reinforcing members to the formed-rigid skin member. The panel-integrating reinforcing members can be fastened to the formed-rigid skin member, at the longitudinal ridges, using screws, bolts, welding, or other fastening or bonding technology such as adhesives.

The substantially flat formed-rigid skin member can be a unitary fabrication, running the full width of the completed panel, or it can comprise a series of interlocking parts where the features that provide the interlocking function are also the longitudinal ridges. Commercially available 1½ inch (37 mm) standing seam snap lock metal roof is an easily accomplished embodiment of a multi-piece formed-rigid skin member.

In an alternative embodiment, the combination of a formed-rigid skin member and panel-integrating reinforcing member is provided in a single “J” section. A complete formed-rigid-skin with multiple panel-integrating reinforcing members then is comprised of multiple “J” sections connected together by screw, welding, or other suitable means.

The shape of the panel-integrating reinforcing members further facilitates their being bonded to the foam insulating core, and to the cementations skin layer. The panel-integrating reinforcing members can take a variety of geometric configurations, and in a preferred embodiment, is a standard structural component (wire reinforcing truss) used for conventional building fabrication, and more particularly, a wire reinforcing truss used for horizontally reinforcing masonry walls.

One function of the panel-integrating reinforcing members is to reduce the deflection of the building panel, and thereby reduce the amount of shear strain presented to the foam insulating core. Further, by being bonded to the panel-integrating reinforcing members, the foam itself is reinforced, thereby giving it resistance to developing separation cracks in the horizontal shear planes.

Another function of the panel-integrating reinforcing members is to transfer loads between the top (compression) skin and the bottom (tension) skin. Being constrained against lateral deflection by being bonded to the foam core, the panel-integrating reinforcing members provide greater stability in the inter-skin spacing, reducing the compression loading on the foam core.

The foam insulating core can comprise sheets cut to a width and length that fits the spacing between the panel-integrating reinforming members, or can be a foam-in-place or sprayed in-place unitary embodiment. Besides providing heat insulating properties for the completed panel, the foam insulating core also defines the boundary for the cementations skin. Further, by being mechanically or otherwise bonded to the panel-integrating reinforcing members, the foam insulating core enhances panel strength and durability.

In addition to the foam insulating core and panel-integrating reinforcing members, the space between the formed-rigid skin and the cementations skin can contain piping, wiring, or any other desired utilities that may be desired for the completed structure.

The cementatious skin layer is cast in place, coming in contact with the foam insulating core. This layer can be further reinforced with conventional reinforcing means such as wire, plastic or fiberglass mesh, kevlar fibers, carbon fibers, etc. and/or can include tubing for radiant heating function.

The exterior surface of the cementatious skin layer can be made “paint ready” (or ready for sealant) with any variety of textures, by using conventional texturing means such as placing burlap or other fabric (or a latex skin or stamp pad) on the surface and tamping, or with a toothed trowel, or with a broom, or with a smooth or embossed roller.

The cementations skin, being soft at the outset of its curing process, can be grooved in a freehand fashion (non-repetitive patterns) to produce a faux-flagstone appearance, or grooved in a regular fashion to produce a faux-tiling appearance. In yet another variation on finishing the cementations skin layer, the surface of the panel takes on the appearance of stone or tile installation having grouted joints when the grooving is performed after painting or other color coating.

The edges of the structurally insulated-integrated building panel can be made of an integral perimeter form made of wood, metal studs, or any prefabricated arrangement (for example, exposed male threads or embedded threaded holes—or metal ridges for assembly by locked-seam welding, etc.) that will facilitate connecting panels to each other and/or to other building features such as foundations, roof trusses, existing beams or columns, etc.

It is contemplated that the building panels will be built off-site, rather than at the building construction site. The building panel fabrication process roughly follows the description of building panel elements recited above. As discussed above, the panel can be built into an integral perimeter form, or in the alternative, panel fabrication can be accomplished using a reusable perimeter form that represents the final length, width and thickness (or height) dimensions of the completed structurally insulated-integrated building panel.

The formed-rigid skin and panel-integrating reinforcing members can be assembled before being placed in the perimeter form, or after being placed in the form. Likewise, any panel edge items, such as studs or panel-to-panel assembly devices, are placed inside the perimeter form. Optionally, any utilities, for example wiring or plumbing, can then placed above the formed-rigid skin, in the space that will further occupied by the foam core material. The foam insulating material is then placed into the spaces between the panel-integrating reinforcing members. If the foam insulating material is rigid sheets, the sheets are bonded to the formed-rigid skins and to each other using layers of adhesive, and the sheets are bonded to the panel-integrating reinforcing members with an injection of adhesive foam such as “Great Stuff”® expanding foam. If the foam insulating material is unitary rather than sheets, i.e., being sprayed or poured in place, it will bond itself to the panel-integrating reinforcing members. After the foam insulating material is bonded in place, any optional cementatious layer reinforcing material (e.g., wire mesh, fiberglass mesh, plastic mesh, reinforcing bars, or the like) or radiant heat tubing is fastened to the panel integrating reinforcing members. The cementatious skin material (or materials, two-layer cementatious skin is a preferred embodiment) is then poured or sprayed to the desired thickness, and at the appropriate time in the curing process, the cementatious skin layer can be textured or smoothed to make the desired paint-ready (or sealant ready) finish.

One embodiment of a structurally insulated-integrated building panel according to the present invention would use a 24 gauge steel for the formed-rigid skin, panel-integrating reinforcing members spaced on 16 or 20 inch centers, made of welded wire (e.g., 9 gauge truss type masonry reinforcement), and fastened to the preformed steel skin with No. 8 sheet-metal screws, 2 inch thick rigid polyisonone boards stacked to make a total of 8 inches thickness, an injected adhesive foam to bond the polyisonone boards to each other and the panel-integrating reinforcing members, a latex bonding agent to ensure good bonding between the foam and the cementatious skin, and a cementatious skin of lightweight polymer concrete.

Alternative embodiments would use aluminum instead of steel, or reinforced fiberglass or similar composite materials for the formed-rigid skin; panel-integrating reinforcing members of formed sheet metal (steel or aluminum) or formed reinforced fiberglass, plastic or similar composite materials instead of a welded wire shape; cast-in-place unitary foam insulation instead of foam insulation boards and injected adhesive foam, or polyisonone or other rigid foam material for insulation. Similarly, the cementations layer can be any one of a variety of commercially available structural cement/aggregate materials, for example Shotcrete® or Gunnite®.

A typical structurally insulated-integrated building panel is intended to be used primarily for floor and roof building elements, but the useful application of the present invention is not limited to those building parts. The structurally insulated-integrated building panel is adaptable to the production of wall and other panels, as well as floor and ceiling parts. A typical finished size of a structurally insulated-integrated building panel is the full width and depth of a household room, where underlying foundation support is required on about 12 foot spacing. A typical floor or ceiling panel might have finished dimensions from about 8 to 14 feet wide by 10 to 40 feet long by 9 to 14 inches thick, but panels can be made in any size that is convenient for transportation, building layout, heat insulation requirements, and structural strength specifications.

The present invention relates to a structurally insulated-integrated building panel that may be adapted and adjusted to optimize size, heat insulating characteristics, integrated heating facilities, integrated utilities, structural strength, surface textures, etc., and further may be adapted by providing integral means to facilitate connecting one panel to another or one panel to a foundation as part of a complete building structure. Specific features of the invention will be apparent from the above and from the following description of the illustrative embodiments when considered with the attached drawings and the appended claims.

In summary, and in accordance with the above discussion, the foregoing objectives are achieved in the following embodiments.

1. A structurally insulated-integrated building panel comprising:

a formed-rigid skin layer and a cementations skin layer held in separated alignment by two or more reinforcing members having longitudinal and elevational axes and top and bottom edges, whereby the separated alignment results in a core space between the formed-rigid skin layer and the cementations skin layer; and

an insulating material disposed in the core space;

wherein the formed-rigid skin layer has a substantially flat surface having longitudinal and cross axes, and wherein the formed-rigid skin layer has elevated ridges running in a longitudinal direction;

the bottom edges of the reinforcing members are located proximate to the elevated longitudinal ridges in the formed-rigid skin layer and are bonded to the formed-rigid skin layer;

the insulating material in the core space is bonded to the reinforcing members; and

the top edges of the reinforcing members are embedded in the cementatious skin.

2. A structurally insulated-integrated building panel as described in paragraph 1, where the elevated longitudinal ridges in the formed-rigid skin layer are normal to the flat surface.

3. A structurally insulated-integrated building panel as described in paragraph 2, where the reinforcing members are metal wire fabrications.

4. A structurally insulated-integrated building panel as described in paragraph 3, where the bottom edges of the reinforcing members are bonded to the longitudinal ridges in the formed-rigid skin layer using self-threading fasteners.

5. A structurally insulated-integrated building panel as described in paragraph 1, where the insulating material comprises rigid expanded foam boards and the insulating material is bonded to the reinforcing members with a foam adhesive.

6. A structurally insulated-integrated building panel as described in paragraph 1, where the insulating material comprises a cured-in-place foam.

7. A structurally insulated-integrated building panel as described in paragraph 1, where the elevated longitudinal ridges are separated in the cross-axial direction to provide “U” shaped troughs, where the width of the “U” shaped troughs is such that the bottom edges of the reinforcing members are restricted from moving in a lateral direction.

8. A structurally insulated-integrated building panel as described in paragraph 3, where the bottom edges of the reinforcing members are bonded to the longitudinal ridges in the formed-rigid skin layer by spot welding.

9. A structurally insulated-integrated building panel as described in paragraph 1, where the formed-rigid skin layer is a reinforced resin composite material and the bottom edges of the reinforcing members are embedded in the longitudinal ridges of the formed-rigid skin layer.

10. A structurally insulated-integrated building panel as described in paragraph 1, where the elevated longitudinal ridges are not at a right angle to the flat surface of the formed-rigid skin layer.

11. A structurally insulated-integrated building panel as described in paragraph 1, where the structurally insulated-integrated building panel further comprises tubing arranged in a serpentine layout, where the tubing is embedded in the cementations skin layer.

12. A structurally insulated-integrated building panel as described in paragraph 1, where the formed-rigid skin layer is a unitary structure.

13. A structurally insulated-integrated building panel as described in paragraph 1, where the formed-rigid skin layer comprises interlocking panels, where each interlocking panel has a male interlocking panel edge and a female interlocking panel edge.

14. A structurally insulated-integrated building panel as described in paragraph 13, where the longitudinal ridges of the formed-rigid skin layer comprise interlocked male and female interlocking panel edges.

15. A structurally insulated-integrated building panel as described in paragraph 1:

where the reinforcing members comprise rigid planar sheets lying in a Y-Z plane defined by the top and bottom edges of the reinforcing members; and

where each rigid planar sheet is cut and parts of the planar sheet are displaced from the Y-Z plane to form wings that intrude into the core space.

16. A structurally insulated-integrated building panel as described in paragraph 15:

where each rigid planar sheet is cut and parts of the planar sheet are displaced from the Y-Z plane to form tabs that are embedded in the cementatious skin layer.

17. A structurally insulated-integrated building panel as described in paragraph 15:

where the wings that intrude into the core space are triangular in shape.

18. A structurally insulated-integrated building panel as described in paragraph 13,

where the reinforcing members comprise rigid planar sheets lying in a Y-Z plane defined by the top and bottom edges of the reinforcing members;

where the formed-rigid skin layer comprises interlocking panels, where each interlocking panel has a male interlocking panel edge and a female interlocking panel edge;

where the bottom edges of the reinforcing members are interlocked with the male interlocking panel edge of a first panel and female interlocking panel edge of a second panel.

19. A structurally insulated-integrated building panel comprising:

a formed-rigid skin layer and a cementatious skin layer held in separated alignment, whereby the separated alignment creates a core space between the formed-rigid skin layer and the cementatious skin layer; and

an insulating material disposed in the core space;

wherein the formed-rigid skin layer comprises multiple skin panels, each skin panel having a “J”-shape comprising a horizontal leg, a long vertical leg, and a short vertical leg;

wherein the skin panels are bonded one to another with the long vertical leg of one skin panel being bonded or fastened to the short vertical leg of an adjacent skin panel;

wherein the thickness of the insulating material in the core space is less than the height of the long vertical legs of the skin panels;

the insulating material in the core space is bonded to the long vertical legs of the skin panels; and

the top edges of the vertical legs of the skin panels are embedded in the cementatious skin.

### BRIEF DESCRIPTION OF THE DRAWINGS

FIG. 1 is a partial cutaway perspective view of one embodiment of a structurally insulated-integrated building panel according to the present invention.

FIG. 2A is an end elevation view of a unitary formed-metal skin.

FIG. 2B is an end elevation view of a multi-piece formed-metal skin.

FIG. 3 is an end elevation view showing various stages of completion of a structurally insulated-integrated building panel.

FIG. 4 is a side elevation view of a welded-wire panel-integrating reinforcing member.

FIG. 5 is a partial side elevation view of a building panel with a welded-wire reinforcing member.

FIG. 6 is a partial side elevation view of a building panel with a single wire reinforcing member.

FIG. 7 is a partial side elevation view of a formed-rigid skin with a panel-integrating reinforcing member attached by welding.

FIG. 8A is a partial end elevation view of a formed-rigid skin and a panel-integrating reinforcing member.

FIG. 8B is a partial end elevation view of an alternative embodiment of a formed-rigid skin.

FIG. 8C is a partial end elevation view of a building panel with another embodiment of a formed-rigid skin.

FIG. 9 is a partial end elevation view of a building panel with sheet foam insulation.

FIG. 10 is a partial end elevation view of a building panel with unitary foam insulation.

FIG. 11A is a partial end elevation view of a building panel where the longitudinal ridge has angled surfaces.

FIG. 11B is a partial end elevation view of a building panel where one edge of the reinforcing member is embedded in the formed-rigid skin layer.

FIG. 12 is a partial cutaway perspective view of a building panel with tubing embedded in the cementatious skin layer.

FIG. 13 is an end elevation view of a building panel with longitudinal edge members.

FIG. 14 is an end elevation view of a building panel with full-height longitudinal edge members.

FIG. 15 is a perspective view of an embodiment that integrates the formed-rigid skin and panel-integrating reinforcing members.

FIG. 16 is an end elevation view of a combined formed-rigid skin and panel-integrating reinforcing member.

FIG. 17 is a partial side elevation view of an integrated reinforcing leg showing slits and fold lines for producing triangular shaped wings.

FIG. 18 is a partial side elevation view of an integrated reinforcing leg showing slits and fold lines for producing rectangular retention tabs.

FIG. 19 is a plan view of an integrated reinforcing leg showing retention tabs.

FIG. 20 is a partial side elevation view of an integrated reinforcing leg showing slits and fold lines for producing rectangular wings.

FIG. 21 is a partial end elevation view of a multi-piece formed-rigid skin and integrating reinforcing member.

FIG. 22 is a partial end elevation view of a joint for a multi-piece formed-rigid skin and integrating reinforcing member.

FIG. 23 is an end elevation view of a curved building panel.

### DESCRIPTION OF THE PREFERRED EMBODIMENTS OF THE PRESENT INVENTION

In one general embodiment, the structurally insulated-integrated building panel of the present invention comprises a sandwich with a formed-rigid skin of sheet metal, a cementatious skin of lightweight fiber reinforced concrete, and a central space filled with a foam insulating material. Panel-integrating reinforcing members in combination with expanding foam adhesive integrate the two skins and the foam insulating layer into a single structural unit.

A feature of the present invention is that the formed-rigid skin includes longitudinal ridges or other features that determine and maintain the location of the panel-integrating reinforcing members. The longitudinal ridges also provide material for convenient fastening or bonding of the panel-integrating reinforcing members to the formed-rigid skin layer.

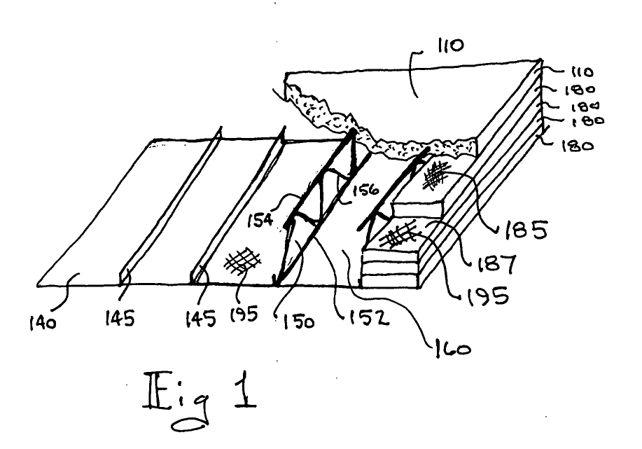

FIG. 1 is a partial cutaway perspective view of one embodiment of a structurally insulated-integrated building panel according to the present invention.

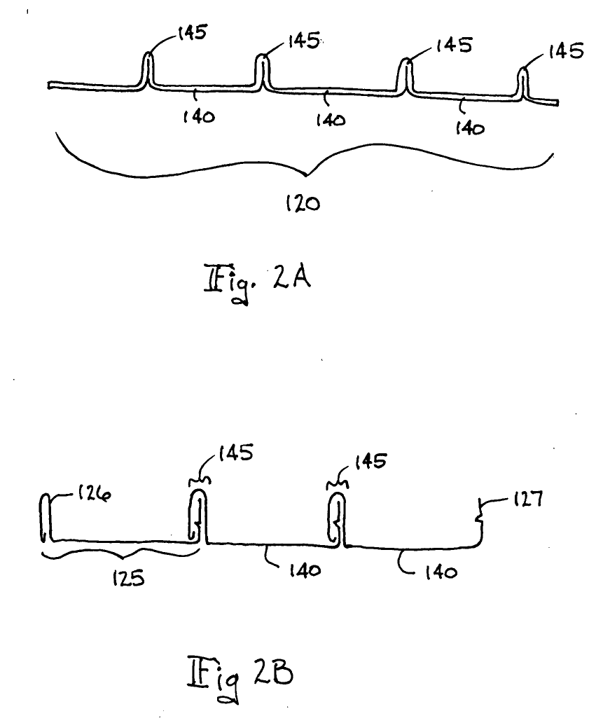

FIG. 2A is an end elevation view of a unitary formed-metal skin.

Formed-rigid skin layer 120 has substantially planar (flat) sections 140 and longitudinal ridges 145 running parallel to each other. Longitudinal ridges 145 can be spaced on 16 to 20 inch (400-500 mm) centers, or can be more closely spaced. When formed-rigid skin layer 120 is made from metal, such as steel or aluminum, longitudinal ridges 145 can be produced by roll-forming. In the preferred embodiment, the surfaces of longitudinal ridges 145 are perpendicular the generally flat plane parts 140 of the formed-rigid skin layer 120, and are about 1½ inches (38 mm) in height.

FIG. 2B is an end elevation view of a multi-piece formed-metal skin.

In the preferred embodiment, formed-rigid skin layer 120 is made of interlocking metal roof panels 125, where longitudinal ridges 145 comprise female interlocking element 126 and male interlocking element 127 of interlocking roof panels 125. Interlocking roof panels 125 are preferably commercially available 1½ inch (37 mm) standing seam snap lock metal roofing.

If formed-rigid skin layer 120 is made from a composite such as fiberglass or kevlar or carbon reinforced resin materials, longitudinal ridges 145 can be integrally formed during the panel lay-up process. In the preferred embodiment, formed-rigid skin layer 120 is 24 gauge steel, but steel or aluminum from 20 to 26 gauge are also suitable materials.

Each reinforcing member 150 is located so that its bottom edge 152 is proximate to a longitudinal ridge 145. Longitudinal ridge 145 to the left in FIG. 1 is shown without an associated reinforcing member 150. The association of each reinforcing member 150 with a longitudinal ridge 145 provides means to align the reinforcing members within the building panel without the use of temporary locating jigs or measuring devices. Longitudinal ridges 145 also provide a location and material that can be used to accomplish the fastening or bonding of reinforcing members 150 to formed-rigid skin layer 120. As illustrated, each longitudinal ridge 145 has an associated reinforcing member 150, but in practice some building panels may be enhanced by having additional longitudinal ridges 145, perhaps of varying spacing and cross section, in order to enhance the rigidity of the formed-rigid skin layer on its own, and/or to provide features that enhance the mechanical bonding of the foam layer to the formed-rigid skin layer.

In the preferred embodiment, panel-integrating reinforcing members 150 are masonry reinforcing trusses made of 9 gauge wire. These welded-wire trusses are typically used for reinforcing horizontal joints in 8 or 10 inch (200 to 250 mm) thick cinder block wall construction, and are available in a variety of configurations. The preferred configuration of panel-integrating reinforcing member 150 has segments of intermediate wire 156 arranged at a 45 degree angle to both lower edge 152 and upper edge 154, and a distance of about 8 and ¾ inches (222 mm) from lower edge 152 and upper edge 154. These dimensions provide about ¾ inch (20 mm) of panel-integrating reinforcing member 150 exposed above an 8 inch (200 mm) layer of foam sheets 180. Cementatious skin layer 110 is preferred to be from about 1 to 1¼ inch (25-32 mm) thick, producing a completed building panel thickness of about 9¼ inch (235 mm).

The arrangement of multiple panel-integrating reinforcing members 150 in parallel alignment, in combination with rigid (tension) skin layer 120, produces one or more spaces 160 between the reinforcing members. These spaces 160 are filled with insulating material, for example, a stack of foam boards 180 can be used to fill spaces 160. FIG. 1 shows a partial length foam boards 180 in one space 160, but the completed building panel contemplates that the full length of all spaces 160 will be filled with insulating material, e.g., foam boards 180 in combination with adhesive layers 195 and expanding foam 190. In the preferred embodiment, foam boards 180 are rigid expanded polyisonone with a thickness of 2, 4 or 8 inches (50, 100 or 200 mm) with a density of between 1.5 and 4 pounds per cubic foot (24 to 65 kilograms per cubic meter). Thicker foam boards 180, i.e. 4 inches (100 mm), are preferred over 2 inch (50 mm) thickness in order to reduce assembly time.

Other foam materials, e.g. polyurethane or expanded polystyrene (EPS) may be used, if desired.

Foam insulating material, e.g., foam boards 180, is (are) bonded to panel-integrating reinforcing members 150 via any one of a variety of means (not shown in this figure). Stacked foam boards 180 are preferably further bonded to each other with adhesive 195, and are also bonded to rigid-formed skin layer 120. Board-to-board, or board to rigid-formed skin layer bonding is typically accomplished using layers 195 of a suitable adhesive material.

The thickness of the insulating foam layer is such that the upper edges 154 of panel-integrating reinforcing members 150, are exposed above the foam insulation. In the preferred embodiment, about ¾ inch (20 mm) of the height of reinforcing members 150 is exposed above the foam insulation layer. The exposed parts (edge 154 and parts of intermediate wire 156) of reinforcing members 150 will become embedded in cementatious skin layer 110.

The top surface 185 of upper foam board 180 is coated with a latex bonding agent 115 to facilitate bonding of the cementations skin layer 110 with upper foam board 180. Latex bonding agent 115 is typically applied with a roller to insure complete coverage.

Cementatious skin layer 110 is poured or sprayed over the foam insulation layer (e.g., made of foam boards 180) to the desired thickness. In the preferred embodiments, cementatious skin layer 110 is made of a lightweight concrete polymer mixture with a finished thickness of about 1¼ inch (32 mm).

In the preferred embodiment, cementatious skin layer 110 comprises an underlayer of about ¾ to 1 inch (20-25 mm) thickness, and an overlay or coating (also known as “topping”) layer of about ¼ inch (6 mm) thickness. The coating layer can be a different color from the underlayer, whereby, when cementatious layer 110 is finished by cutting grooves, the grooves will exhibit the color of the underlayer, while the primary surface of cementatious skin layer 110 will exhibit the color of the coating layer. FLEX-C-MENT division of Yoder and Sons, LLC of Greer, S.C. produces lightweight fiber reinforced concrete materials that have been used with success in the present invention, where the preferred materials have a 4,000 PSI strength rating.

Cementatious skin layer 110 can further be reinforced by providing a wire mesh, plastic mesh, or similar reinforcing mat (not illustrated), where the reinforcing structure is attached to reinforcing members 150 before the cementations layer is poured or sprayed onto the foam insulating layer.

Exposed side edges 130 of a finished structurally insulated-integrated building panel may show the thickness of cementations skin layer 110 and the thickness of the insulating layer, e.g., foam boards 180. An alternative embodiment of the building panel, discussed below, incorporates additional components that hide the insulating layer and produce exposed side edges 130 that are something other than cementatious skin layer 110 and rigid foam insulating boards 180.

FIG. 3 is an end elevation view showing various stages of completion of a structurally insulated-integrated building panel.

Formed-rigid skin 120 comprising flat areas 140 and longitudinal ridges 145 can be placed in a construction form having longitudinal perimeter members 900. The construction form would also have end perimeter members (not shown) to contain all edges of a pour or spray of cementations layer 110.

Formed-rigid skin 120 can be pretensioned between longitudinal perimeter form members 900 using any suitable gripping and holding facilities, for example, threaded rod welded to or embedded in formed-rigid skin 120.

Lower edge 152 of panel-integrating reinforcing members 150 are located proximate to longitudinal ridges 145, and are fastened or bonded thereto. Foam material, e.g., foam boards 180 are arranged to fill spaces 160 between reinforcing members 150. Foam boards 180 are bonded to panel-integrating reinforcing members 150 with an injection of an expanding adhesive foam 195. In the preferred embodiment, “Great Stuff”® expanding foam is used as both, the gap filling and the board to board bonding material.

After the foam insulating layer has been placed and bonded to the formed-rigid skin 120 and panel integrating reinforcing members 150, the cementatious skin layer 110 can be cast or sprayed to the desired thickness, being contained by the construction form (which comprises longitudinal perimeter members 900 and end perimeter members, not shown).

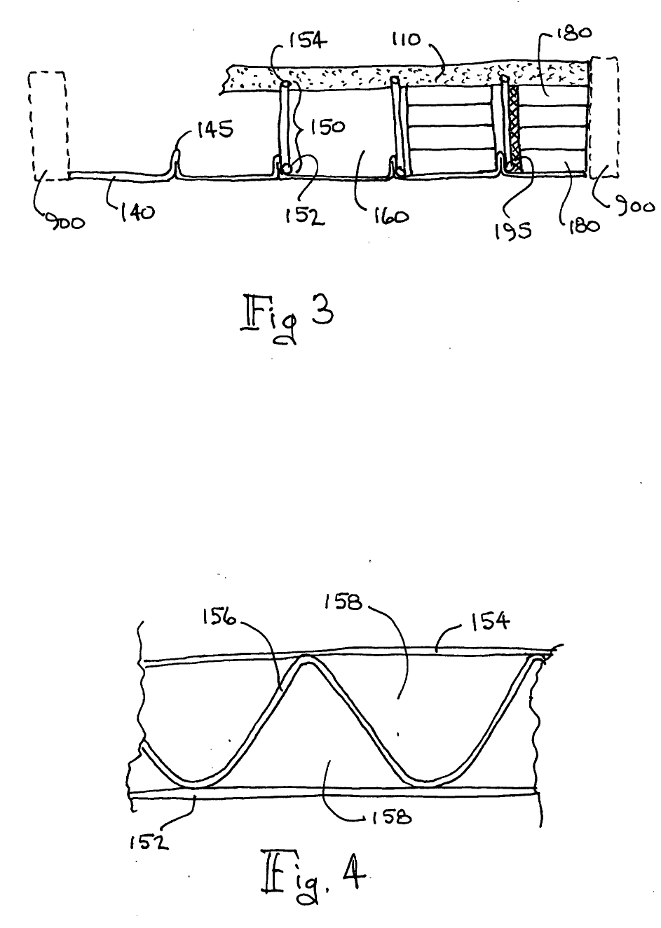

FIG. 4 is a side elevation view of a welded-wire panel-integrating reinforcing member.

The preferred panel-integrating reinforcing members 150 illustrated and discussed above are a welded-wire fabrication, comprising a lower wire 152, an upper wire 154 and an intermediate wire 156. The arrangement of the wires produces spaces 158 in reinforcing members 150. The injected expanding foam adhesive 195 in FIG. 3 will fill the spaces 158, and will bond foam boards 180 to wires 152 and 156. Upper wire 154 and parts of intermediate wire 156 will be exposed above the foam insulating layer, and will become embedded in cementations skin layer 110.

After the cementatious skin layer 110 and adhesive foam 195 are sufficiently cured, the construction form can be opened or otherwise removed from the building panel. However, in the preferred embodiment, the construction form becomes an integral part of the completed building panel.

FIG. 5 is a partial side elevation view of a building panel with a welded-wire reinforcing member.

Panel-integrating reinforcing members 150 are preferably fastened to longitudinal ridges 145 of formed-rigid skin 120 using threaded fasteners 200. FIG. 5 illustrates an embodiment where the shoulders under the heads of fasteners 200 bear against both lower wires 152 and intermediate wires 156 of reinforcing members 150.

When using the preferred welded-wire reinforcing member 150, the arrangement of FIG. 5 will provide two threaded fasteners 200 in each pitch of intermediate wires 156, about 16 inches (400 mm) on centers, using the preferred reinforcing member 150.

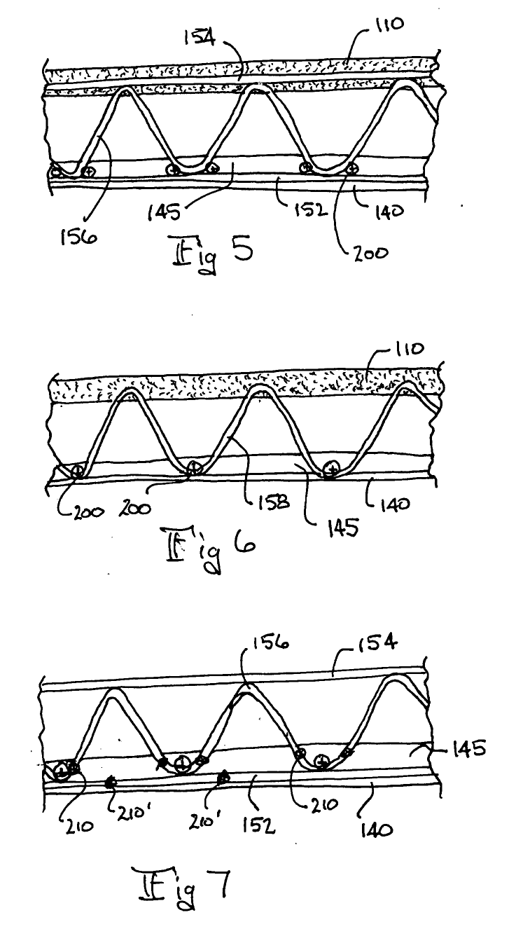

FIG. 6 is a partial side elevation view of a building panel with a single wire reinforcing member.

Panel-integrating reinforcing members 158 are preferably fastened to longitudinal ridges 145 of formed-rigid skin 120 using threaded fasteners 200. FIG. 6 illustrates an embodiment where the panel-integrating reinforcing members comprise only a single bent wire 158. In this embodiment, shoulders under the heads of fasteners 200 bear only against bent panel-integrating reinforcing wires 158.

When using the single wire reinforcing member 158, the arrangement of FIG. 6 will provide one threaded fastener 200 in each about 16 inches (400 mm).

FIG. 7 is a partial side elevation view of a formed-rigid skin with a panel-integrating reinforcing member attached by welding.

Wires 156 and/or 152 of reinforcing members 150 can be bonded to longitudinal ridges 145 with spot or resistance welds. Weld spot 210 represents the bonding of a wire 156 to a longitudinal ridge 145, and weld spot 210′ represents the bonding of a wire 152 to a longitudinal ridge 145. Wire 152 could also be bonded to flat surface 140. The spacing, pattern, and pitch of spot or resistance welds can be varied to suit the strength requirements. For maximum strength, a full length welded bond can be produced, and is contemplated to be within the scope of the present invention.

A given building panel can use a combination of the single wire 158 and welded wire 150 panel-integrating reinforcing member as shown in FIGS. 5, 6 and 7.

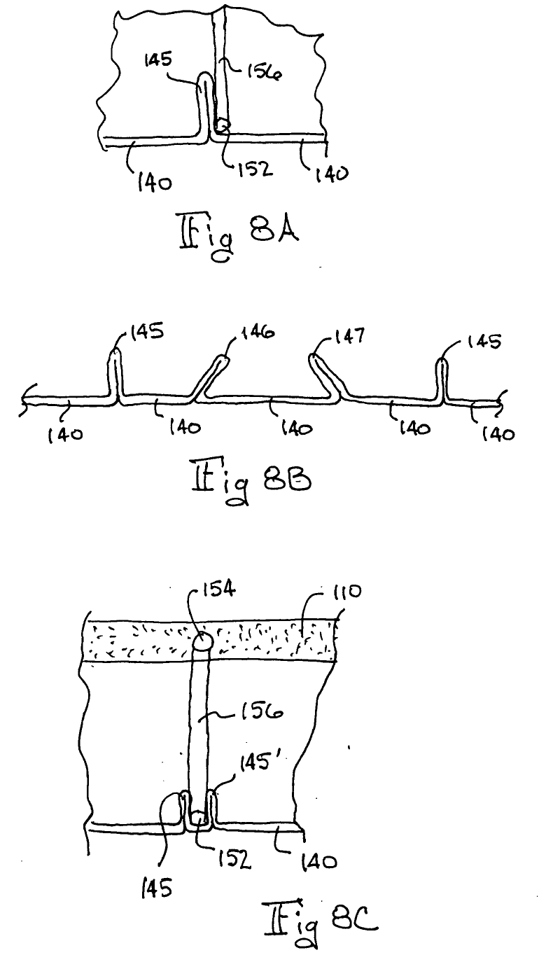

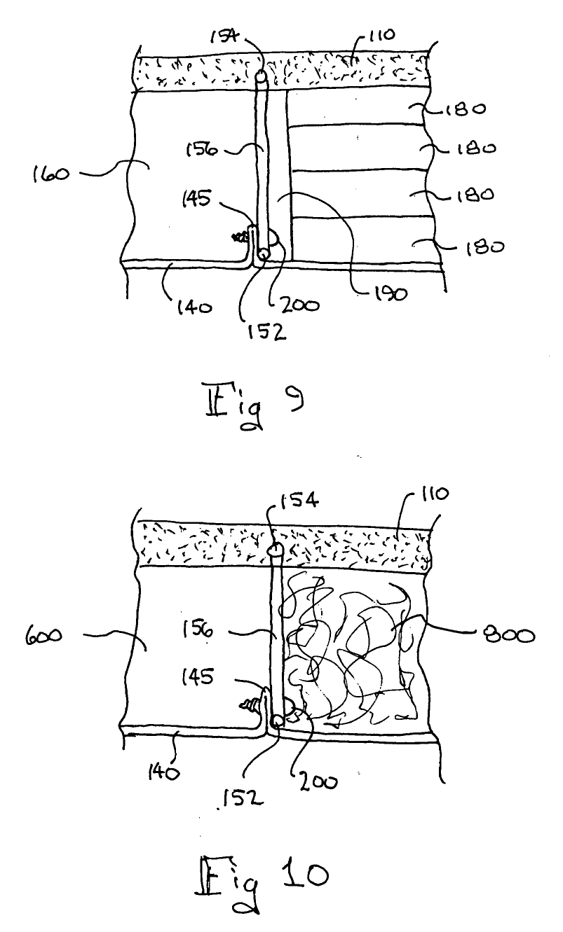

FIG. 8A is a partial end elevation view of a formed-rigid skin and a panel-integrating reinforcing member.

Lower wire 152 and intermediate wire 156 of reinforcing members 150 are located adjacent to the surface of longitudinal ridges 145. The surfaces of Longitudinal ridges 145 can be perpendicular to the nominally planar (flat) surfaces 140 of formed-rigid skin 120 as shown in FIG. 8A.

FIG. 8B is a partial end elevation view of an alternative embodiment of a formed-rigid skin.

Longitudinal ridges 145 of the formed-rigid skin illustrated in FIG. 8B are the same as illustrated in FIG. 8A. But the formed-rigid skin 120 of FIG. 8B has additional longitudinal ridges 146 and 147 that are not perpendicular to the nominal planar (flat) surfaces 140. In the formed-rigid skin of FIG. 8B, the additional longitudinal ridges are not used to locate and/or bond panel-integrating reinforcing members. As illustrated, longitudinal ridges 146 and 147 would provide mechanical bonding of a foamed-in-place insulating core material to skin layer 120, and also, on their own, increase the bending stiffness of skin 120 beyond the level provided if longitudinal ridges 145 were provided only on the spacing of the reinforcing members 150.

FIG. 8C is a partial end elevation view of a building panel with another embodiment of a formed-rigid skin.

An alternative arrangement of longitudinal ridges 145 and 145′ can be provided, whereby the space between adjacent longitudinal ridges 145 and 145′ is such that wires 152 and 156 fit with either a slight amount of interference, to a slight amount of clearance (e.g., 1 to 2 mm). With suitably tall longitudinal ridges 145 and 145′, panel-integrating reinforcing members 150 (made of wires 152, 154 and 156), or panel-integrating reinforcing wire 158, will stand in their upright position without assistance, thereby freeing both of a worker's hands for bonding the panel integrating reinforcing members to the formed-rigid skin layer.

FIG. 9 is a partial end elevation view of a building panel with sheet foam insulation.

Wires 152 of reinforcing members 150 are located adjacent to, and drawn snug against longitudinal ridges 145 with the use of multiple threaded fasteners 200. A stack of rigid foam boards 180 is shown filling most, but not all of one cavity 160. A volume 190 is provided between foam boards 180 and various other parts, i.e., wires 156, wires 152 and fasteners 200. Volume 190 is occupied by expanding adhesive foam (not illustrated), which will bond the foam boards 180 to wires 156.

The trapping of intermediate wires 156 of welded wire truss 150 (or bent wire 158) within the expanding adhesive foam (and the resulting bonding of wire 156 or 158 to foam boards 180 or unitary foam core 800) prevents their lateral bending when under compressive loading, and thereby facilitates the direct transfer of loads between formed-rigid skin 120 and cementatious skin 110. Further, the adhesively bonded foam board structure (or unitary foam structure) is strengthened by being bonded to reinforcing wires 156 or 158. The tendency of the foam core to degrade under dynamic loading, by developing cracks in the horizontal shear planes, is thereby reduced.

Fabrication of a building panel using stacked foam insulating boards 180 and expanding foam adhesive takes advantage of materials commonly found in building supply warehouses, and is therefore the preferred embodiment for producing an insulating core that is bonded to the formed-rigid skin 120, reinforcing members 150, and cementatious skin 110.

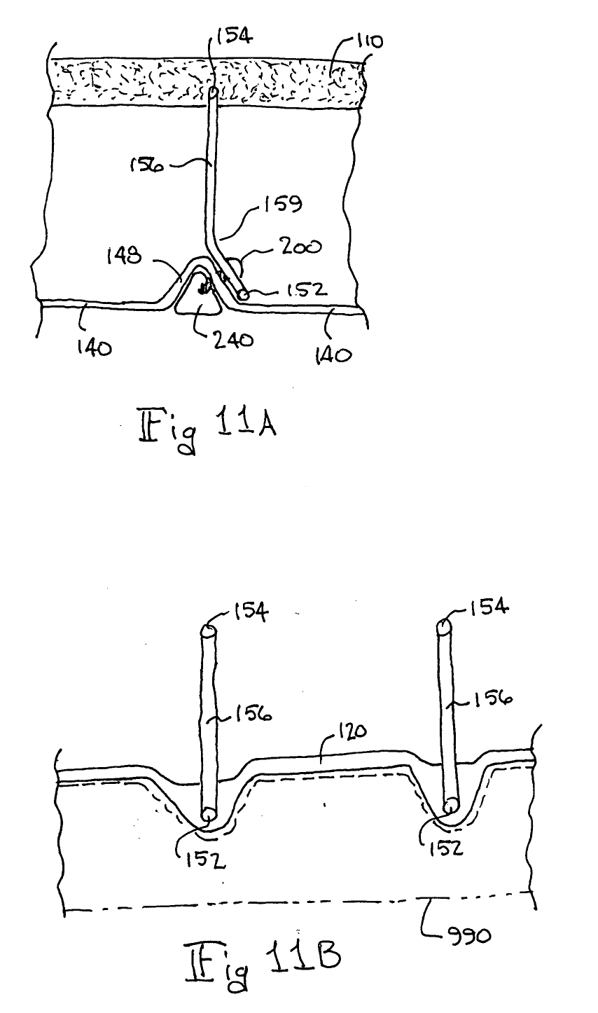

FIG. 10 is a partial end elevation view of a building panel with unitary foam insulation.

An alternative to the stacked rigid insulating foam boards in combination with expanding foam adhesive is contemplated to be advantageous, depending on the facilities and expertise of the building panel fabricator. The building panel of FIG. 10 is prepared for the addition of the insulating foam as discussed above, i.e., by bonding wires 156 and/or wires 152 to longitudinal ridges 145. But instead of stacking insulating foam boards 180 in cavities 160 as illustrated in FIG. 9, a unitary foam insulation 800 is sprayed or poured in place. The preferred minimum foam density s about 3 pounds per cubic foot (48 kg per cubic meter).

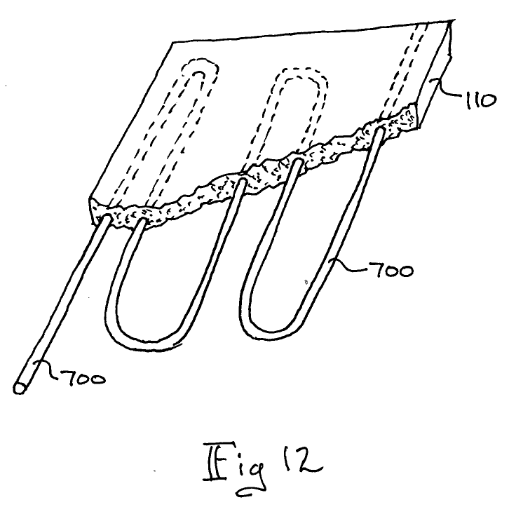

FIG. 11A is a partial end elevation view of a building panel where the longitudinal ridge has angled surfaces.

If a composite material, e.g., glass or fiber reinforced resins, are used to produce the formed-rigid skin member, it is advantageous that longitudinal ridges 148 provide surfaces that are not perpendicular to the generally flat plane 140 of formed-rigid skin 120. In this embodiment, reinforcing members 150 can be provided with a longitudinal bend 159 that corresponds with the geometry of longitudinal ridge 148, so that the majority of length of wires 156 is arrayed in a plane that is perpendicular to the plane of flat surfaces 140.

This arrangement has the advantage of presenting the head of threaded fastener 200 in a direction that facilitates driving it, that is, not close to surface 140, and not in a direction that is parallel with the floor of the workplace. Rather, the direction of driving fastener 200 in the arrangement of FIG. 11A is such that a worker need not place his or her hands and knuckles directly against formed-rigid skin 120.

In some cases, depending on the material used to produce formed-rigid skin 120, the threads of fastener 200 may easily strip or otherwise not grip the formed rigid skin 120. A backing strip 240 of a suitable material (e.g., metal, wood) can be provided for gripping the threads of fasteners 200, or in the alternative (not illustrated), washers and nuts can be provided to perform the clamping function that backing strip 240 would provide.

FIG. 11B is a partial end elevation view of a building panel where one edge of the reinforcing member is embedded in the formed-rigid skin layer.

Yet another embodiment of the bonding between formed-rigid skin 120 and panel-integrating reinforcing members 150 has lower edge 152 of panel-integrating reinforcing members 150 (or panel-integrating wire 158) embedded or cast directly into formed-rigid skin 120. This method of bonding is particularly advantageous when formed-rigid skin 120 is made of a reinforced resin composite material, and the composite layup form (dashed lines 990) can be used to locate and align the panel-integrating reinforcing members 150).

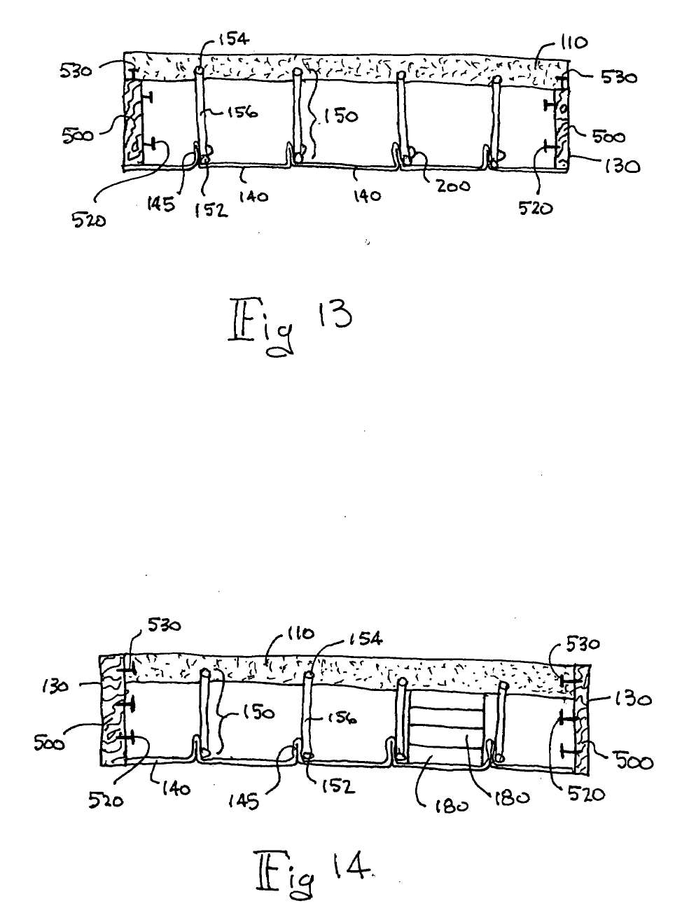

FIG. 12 is a partial cutaway perspective view of a building panel with tubing embedded in the cementations skin layer.

A building panel with a cementations skin layer 110 lends itself to the installation of tubing 700 for the purpose of radiant heating. The desired serpentine arrangement of tubing 700 can be assembled to the reinforcing members 150 or otherwise generally fixed in place (e.g., using stand-offs driven into, cast into, or resting placed on top of the foam insulating layer) before the cementations layer 110 is poured or sprayed. Tubing 700 is preferably cross-linked PEX plastic.

FIG. 13 is an end elevation view of a building panel with longitudinal edge members.

The building panel of FIG. 1 has exposed edges of foam boards 180 and cementatious skin layer 110. Having these materials exposed presents several issues. First, foam insulation 180 and concrete 110 are typically not suitable for attaching one panel to another without additional reinforcement means and attachment means. While in some applications, e.g., room sized floors resting on joists or foundations, the absence of panel to panel attachment means is not an issue, in general it is desirable to have external edges that provide or accept fasteners such as nails, screws and/or adhesives.

A further shortcoming in having exposed edges of foam insulation 180 is risk of ingress of water or other contaminants. A further shortcoming in having exposed edges of the cementations skin 110 is the risk of chipping and other damage.

The building panel of FIG. 13 incorporates longitudinal edge members 500 that span the thickness of the foam core (and only the foam core). Edge members 500 are placed before the cementations skin layer is poured or sprayed. Edge members 500 can be made of wood, or can be formed sheet metal “studs.” Optionally, edge members 500 can be fitted with foam core retention knobs 520 that will (if of a suitable shape and size) or can be (e.g., with the use of an additional adhesive) bonded to the foam core material. In still another embodiment, retention knobs 530 can be provided to bond edge members 500 to cementations layer 110. In yet another embodiment, e.g. use of a sheet metal “stud” for edge member 500, the edge member 500 can have integrally-formed features that will provide gripping to the foam core and/or the cementatious skin layer.

FIG. 14 is an end elevation view of a building panel with full-height longitudinal edge members.

The building panel of FIG. 14 incorporates longitudinal edge members 500 that span the thickness of the building panel (i.e., foam core plus the thickness of the cementations skin layer). Edge members 500 are placed before the cementations skin layer is poured or sprayed. Edge members 500 can be made of wood, or can be formed sheet metal “studs.” Optionally, edge members 500 can be fitted with retention knobs 520 that will (if of a suitable shape and size) or can be (e.g., with the use of an additional adhesive) bonded to the foam core material. As above, edge members 500 can, instead of separate retention knobs 520 and/or 530, have integrally-formed features that will provide gripping to the foam core and/or the cementatious skin layer.

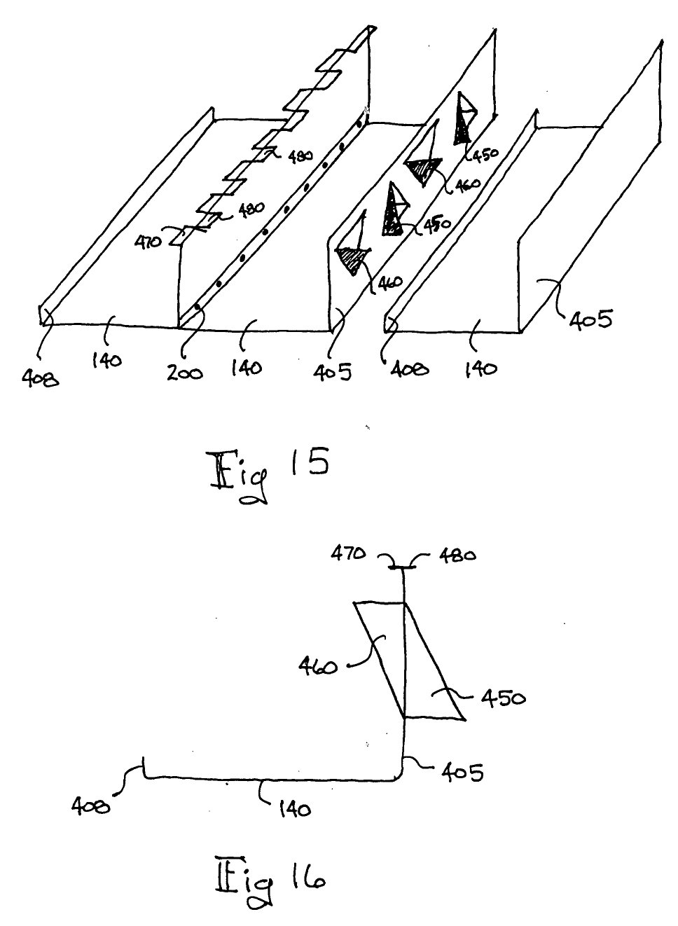

FIG. 15 is a perspective view of an embodiment that integrates the formed-rigid skin and panel-integrating reinforcing members.

FIG. 16 is an end elevation view of a combined formed-rigid skin and panel-integrating reinforcing member.

A series of roughly “J” panel section fabrications can be produced, and attached to each other, to result in a formed-rigid skin/panel-integrating reinforcing members unit that can be filled with insulating foam and covered with a cementatious skin layer, as described above.

In the embodiment of FIG. 15, several panel sections 400 are bonded to each other, using screws 200, welding, or other suitable means. Panel sections 400 may be made from any material that has good strength in tension, but in the preferred embodiments, panel sections 400 are made from 12 to 20 gauge steel or aluminum.

Each panel section 400 has a substantially flat portion 140 (the bottom of the “J”), an integrating-reinforcing leg 405 (the long leg of the “J”) that is approximately perpendicular to substantially flat portion 140, and a fastening lip 408 (the short leg of the “J”), also approximately perpendicular to substantially flat portion 140. To assemble one panel section 400 to another, fastening lip 408 is of one section 400 abutted to integrating-reinforcing leg 405 of a second panel section 400, and sheet metal screws 200 are used to join the panel sections together.

In order to provide good bonding between integrated-reinforcing legs 405 and the foam insulating core material that comprises a completed building panel, integrated-reinforcing legs 405 are preferably slit and deformed to produce triangular shaped wings 450 and 460. Wings 450 and 460 are preferred and illustrated protruding in alternating opposite directions (that is, one wing 450 protrudes on one side of leg 405, and the adjacent wing 450 protrudes on the other side of leg 405), but it is envisioned that all wings 450 could protrude in the same direction, while all wings 460 protrude in the opposite direction from wings 450.

In order to provide good bonding between integrated-reinforcing legs 405 and the cementations skin layer 110 that comprises a completed building panel, integrated-reinforcing legs 405 are preferably slit and deformed to produce retention tabs 470 and 480. Retention tabs 470 and 480 are preferred and illustrated protruding in alternating opposite directions, but it is envisioned that, in lieu of retention tabs, the entire upper section of integrated reinforcing leg 405 could be bent in either direction, to be parallel with substantially flat portion 140 of formed-rigid skin 120.

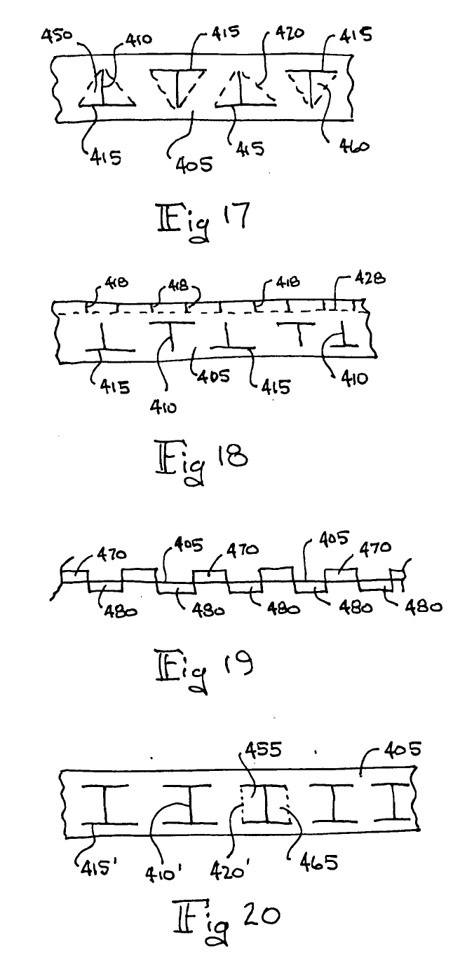

FIG. 17 is a partial side elevation view of an integrated reinforcing leg showing slits and fold lines for producing triangular shaped wings.

FIG. 18 is a partial side elevation view of an integrated reinforcing leg showing slits and fold lines for producing rectangular retention tabs.

FIG. 19 is a plan view of an integrated reinforcing leg showing retention tabs.

Wings 450 and 460 in the integrated-reinforcing leg portion 405 of panel section 400 are produced by making a series of “T” shaped slits having horizontal slit portions 415 and vertical slit portions 410. In the preferred embodiment, the slit pattern alternates between “T” and “inverted T.” The horizontal slits 415 are from 6 to 10 inches (150 to 250 mm) long, and vertical slits 410 are about 6 inches (150 mm) tall. Triangular wings 450 and 460 are produced by folding the blank on fold lines 420.

Retention tabs 470 and 480 in the integrated-reinforcing leg portion 405 of panel section 400 are produced by making a series of vertical slits 418 of about ½ inch (12 mm) length. In the preferred embodiment, vertical slits 418 are from 3 to 10 inches (75 to 250 mm) apart. Rectangular retention tabs 470 and 480 are produced by folding the blank on fold lines 428.

FIG. 20 is a partial side elevation view of an integrated reinforcing leg showing slits and fold lines for producing rectangular wings.

The integrated-reinforcing leg portion 405 of panel section 400 can be slit in an “I” or “H” pattern, to produce rectangular wings 455 and 465. Vertical slits 410′ of about 6 inch (150 mm) length, and horizontal slits 415′ of from 6 to 10 inches (150-250 mm) long are arranged so that folding on fold lines 420′ will produce rectangular wings 455 and 465 of about 6 inch (150 mm) height, and from 3 to 5 inch (75-125 mm) width.

The drawings illustrate wings pushed (folded) to be perpendicular to integrated-reinforcing leg portion 405 of panel section 400, but the wings could be pushed or folded to any angle that provides the direction and amount of area for bonding to the foam core material. Likewise, the drawings illustrate vertical and horizontal slits, but the slits could be in any manner of orientation, in order to produce advantageous wing geometry for the completed structurally insulated-integrated building panel.

FIG. 21 is a partial end elevation view of a multi-piece formed-rigid skin and integrating reinforcing member.

Formed interlocking roof panels 125, each having a longitudinal female interlocking element 126 and a longitudinal male interlocking element 127, can be adapted to further interlock with an integrating-reinforcing member 600. In one embodiment, integrating reinforcing member 600 resembles the structure of integrated-reinforcing leg portion 405 of panel section 400 (e.g., as illustrated in FIGS. 15 to 20), but instead of reinforcing member 600 being an integral part of a panel section, reinforcing members 600 are adapted to be interlocked to and assembled with interlocking roof panels 125.

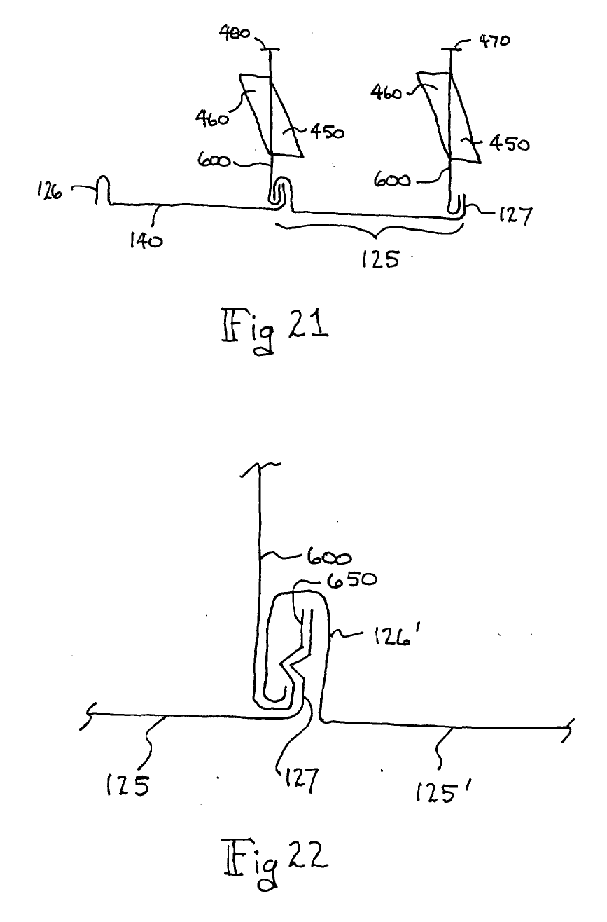

FIG. 22 is a partial end elevation view of a joint for a multi-piece formed-rigid skin and integrating reinforcing member.

Bent lower edge 650 of reinforcing member 600 is abutted to longitudinal male interlocking element 127 of one interlocking roof panel 125. Bent lower edge 650 of reinforcing member 600 and male interlocking element 127 are then captured by longitudinal female interlocking element 126′ of second interlocking roof panel 125′. Further securing can be obtained by running sheet metal screws through the assembled joint, similar to the arrangement illustrated in FIG. 9, or by stitch, seam, or spot welding.

Other geometries of mutually interlocking edges are foreseen to be in the scope of the present invention, for example, where the bottom edge of integrating-reinforcing member 600 has an inverted “U” shape with sufficient width to straddle the outside of (now male) interlocking member 126′.

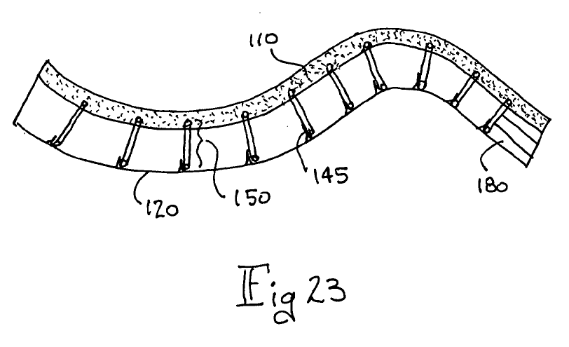

FIG. 23 is an end elevation view of a curved building panel.

While the simplest embodiments of the present invention are “flat” or “planar” structurally insulated-integrated building panels, it is envisioned that curved embodiments may also be conveniently produced, using suitable construction forms and fabrication materials.

For example, a cylindrical silo-like structure could be produced by assembling a series of curved panels. While the description above is couched in terms of a horizontal assembly and pouring operation, the assembly of formed-rigid skin 120 and integrating-reinforcing members 150 can be done while a panel (i.e., wall) is vertical. Further, while cured foam sheets lack flexibility, a foam-in-place operation using a suitable form to produce the desired surface contour on the insulating foam is well-known, and can be used to produce insulating core 800 with a curved surface, while leaving parts of integrating-reinforcing members 150 exposed for being embedded in cementations skin layer 110. Finally, spray in place concrete mixtures, I.e., for use on walls, is also a known art, and can be used to produce curved cementations skin layer 110.

The present invention, described above, relates to a structurally insulated-integrated building panel. Features of the present invention are recited in the appended claims. The drawings contained herein necessarily depict structural features and embodiments of the structurally insulated-integrated building panel, useful in the practice of the present invention.

However, it will be appreciated by those skilled in the arts pertaining thereto, that the present invention can be practiced in various alternate forms, proportions, and configurations. Further, the previous detailed descriptions of the preferred embodiments of the present invention are presented for purposes of clarity of understanding only, and no unnecessary limitations should be implied therefrom. Finally, all appropriate mechanical and functional equivalents to the above, which may be obvious to those skilled in the arts pertaining thereto, are considered to be encompassed within the claims of the present invention.

What I claim is:

1. A structurally insulated-integrated building panel comprising:
a formed-rigid skin layer and a cementations skin layer held in separated alignment by two or more reinforcing members having longitudinal and elevational axes and top and bottom edges, whereby the separated alignment results in a core space between the formed-rigid skin layer and the cementatious skin layer; and
an insulating material disposed in the core space;
wherein the formed-rigid skin layer has a substantially flat surface having longitudinal and cross axes, and wherein the formed-rigid skin layer has elevated ridges running in a longitudinal direction;
the bottom edges of the reinforcing members are located proximate to the elevated longitudinal ridges in the formed-rigid skin layer and are bonded to the formed-rigid skin layer;
the insulating material in the core space is bonded to the reinforcing members; and
the top edges of the reinforcing members are embedded in the cementations skin.

2. A structurally insulated-integrated building panel as described in claim 1, where the elevated longitudinal ridges in the formed-rigid skin layer are normal to the flat surface.

3. A structurally insulated-integrated building panel as described in claim 2, where the reinforcing members are metal wire fabrications.

4. A structurally insulated-integrated building panel as described in claim 3, where the bottom edges of the reinforcing members are bonded to the longitudinal ridges in the formed-rigid skin layer using self-threading fasteners.

5. A structurally insulated-integrated building panel as described in claim 1, where the insulating material comprises rigid expanded foam boards and the insulating material is bonded to the reinforcing members with a foam adhesive.

6. A structurally insulated-integrated building panel as described in claim 1, where the insulating material comprises a cured-in-place foam.

7. A structurally insulated-integrated building panel as described in claim 1, where the elevated longitudinal ridges are separated in the cross-axial direction to provide “U” shaped troughs, where the width of the “U” shaped troughs is such that the bottom edges of the reinforcing members are restricted from moving in a lateral direction.

8. A structurally insulated-integrated building panel as described in claim 3, where the bottom edges of the reinforcing members are bonded to the longitudinal ridges in the formed-rigid skin layer by spot welding.

9. A structurally insulated-integrated building panel as described in claim 1, where the formed-rigid skin layer is a reinforced resin composite material and the bottom edges of the reinforcing members are embedded in the longitudinal ridges of the formed-rigid skin layer.

10. A structurally insulated-integrated building panel as described in claim 1, where the elevated longitudinal ridges are not at a right angle to the flat surface of the formed-rigid skin layer.

11. A structurally insulated-integrated building panel as described in claim 1, where the structurally insulated-integrated building panel further comprises tubing arranged in a serpentine layout, where the tubing is embedded in the cementations skin layer.

12. A structurally insulated-integrated building panel as described in claim 1, where the formed-rigid skin layer is a unitary structure.

13. A structurally insulated-integrated building panel as described in claim 1, where the formed-rigid skin layer comprises interlocking panels, where each interlocking panel has a male interlocking panel edge and a female interlocking panel edge.

14. A structurally insulated-integrated building panel as described in claim 13, where the longitudinal ridges of the formed-rigid skin layer comprise interlocked male and female interlocking panel edges.

15. A structurally insulated-integrated building panel as described in claim 1:
where the reinforcing members comprise rigid planar sheets lying in a Y-Z plane defined by the top and bottom edges of the reinforcing members; and
where each rigid planar sheet is cut and parts of the planar sheet are displaced from the Y-Z plane to form wings that intrude into the core space.

16. A structurally insulated-integrated building panel as described in claim 15:
where each rigid planar sheet is cut and parts of the planar sheet are displaced from the Y-Z plane to form tabs that are embedded in the cementatious skin layer.

17. A structurally insulated-integrated building panel as described in claim 15:
where the wings that intrude into the core space are triangular in shape.

18. A structurally insulated-integrated building panel as described in claim 13,
where the reinforcing members comprise rigid planar sheets lying in a Y-Z plane defined by the top and bottom edges of the reinforcing members;
where the formed-rigid skin layer comprises interlocking panels, where each interlocking panel has a male interlocking panel edge and a female interlocking panel edge;
where the bottom edges of the reinforcing members are interlocked with the male interlocking panel edge of a first panel and female interlocking panel edge of a second panel.

19. A structurally insulated-integrated building panel comprising:
a formed-rigid skin layer and a cementations skin layer held in separated alignment, whereby the separated alignment creates a core space between the formed-rigid skin layer and the cementatious skin layer; and
an insulating material disposed in the core space;
wherein the formed-rigid skin layer comprises multiple skin panels, each skin panel having a “J”-shape comprising a horizontal leg, a long vertical leg, and a short vertical leg;
wherein the skin panels are bonded one to another with the long vertical leg of one skin panel being bonded or fastened to the short vertical leg of an adjacent skin panel;
wherein the thickness of the insulating material in the core space is less than the height of the long vertical legs of the skin panels;
the insulating material in the core space is bonded to the long vertical legs of the skin panels; and
the top edges of the vertical legs of the skin panels are embedded in the cementations skin.
